(19) United States
(12) Patent Application Publication
(10) Pub. No.: US 2005/0198651 A1
(43) Pub. Date: Sep. 8, 2005

(54) Designer for software method signatures

(75) Inventors: Steven Eliot Weil, Bellevue, WA (US); Grayson David Myers, Seattle, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/794,896

(22) Filed: Mar. 5, 2004

(51) Int. Cl. G06F 13/00

(52) U.S. Cl. 719/328; 719/320; 719/330

(57) ABSTRACT

A user interface for creating method signatures on a visual design surface is disclosed. The user interface allows for an efficient and natural utilization of key strokes in creating the method signature through the use of key binding and a hierarchical tree grid control window. Keyboard characters are parsed to place data defining the method signature into cells of the tree grid control window based on the key bindings.

### FIELD OF THE INVENTION

Aspects of the present invention relate to a user interface for creating method signatures. More specifically, aspects of the present invention provide a user interface for creating method signatures for an application component on a visual design surface.

### BACKGROUND

Defining methods for software objects or modules is an important part of the software design cycle. Typically, the creation of method signatures or application programming interfaces (APIs) must be specified in a programming language. The use of programming languages, however, requires adhering to detailed syntax which is undesirable, as an architect or business analyst may not be experts in the particular programming language being utilized to create a method signature.

In order to simply the creation of method signatures, template type forms and wizards have been utilized in order to assist developers and users. These template type forms and wizards, however, are clumsy user interface requiring many key strokes and/or mouse clicks to enter data into the user interface. In addition, the template type forms may be unfamiliar to experienced programmers. For example, FIG. 1 shows a screen shot of one prior art user interface that is used to create a method in Microsoft® Visual Studio®. As shown in FIG. 1, Microsoft® Visual Studio® incorporates an add method wizard 100 that allows a user to input data into a template type form 102 in order to assist a developer or user in creating a method. Though the add method wizard 100 assists a developer or user in creating methods, the template type form 102 is key stroke intensive as a developer or user must tab to, or highlight each field individually in order to enter data into template type form 102. For example, in order to enter data into Method access field 104 of template type form 102, a developer or user must first select Method access field 104 and then type the corresponding data directly into Method access field 104. Similarly, in order to enter data into the Return type field 106, a developer or user must select the Return type field 106 and then type the corresponding data directly into Return type field 106. This process continues until the fields in the template type form 102 are completed.

As another example, FIG. 2 illustrates a screen shot of another prior art user interface that is used to create a method in Microsoft® Visual Vision®. As shown in FIG. 2, Microsoft® Vision® provides a method builder based on selection of various categories 202. When a developer or user selects the categories 202, a grid type structure 204 is displayed for entering data pertaining to the selected categories 202. Though the use of the grid type structure 204 assists a developer or user in creating methods, the grid type structure 204 is keystroke intensive and requires a developer or user to individually highlight or select each field in order to enter data pertaining to the method.

Therefore, there is a need in the art for an improved user interface for building method signatures that assists developers and users in building methods, does not require knowledge about the syntax for a particular programming language, and is not key stroke intensive.

### BRIEF SUMMARY

Aspects of the present invention address one or more of the issues mentioned above, thereby providing a user interface for creating a method signature for an application component on a visual design surface. The user interface allows for an efficient utilization of key strokes in creating the method signature through the use of key binding and a hierarchical tree grid control window. The entered keyboard characters are parsed in real time to place data defining the method signature into cells of the tree grid control window based on the key bindings.

### BRIEF DESCRIPTION OF THE DRAWINGS

Aspects of the present invention are described with respect to the accompanying figures, in which like reference numerals identify like elements, and in which:

FIG. 1 illustrates a prior implementation for the creation of a method signature using a method wizard of Microsoft® Visual Studio®;

FIG. 2 illustrates another prior implementation for the creation of a method signature using a method builder of Microsoft® Visio®;

FIG. 3 illustrates a functional block diagram of a conventional general-purpose computer system;

FIG. 4 illustrates a screen shot of a user interface showing an initial state for creating a method signature for an application component in accordance with an embodiment of the present invention;

FIG. 5 illustrates a screen shot showing the addition of a method signature in accordance with an embodiment of the present invention;

FIG. 6 illustrates another screen shot showing the addition of a method signature in accordance with an embodiment of the present invention;

FIG. 7 illustrates a third screen shot showing the addition of a parameter to the method signature in accordance with an embodiment of the present invention;

FIG. 8 illustrates a fourth screen shot showing a created method signature in accordance with an embodiment of the present invention; and

FIG. 9 illustrates a method of creating a method signature for an application component on a visual design surface in accordance with an embodiment of the present invention.

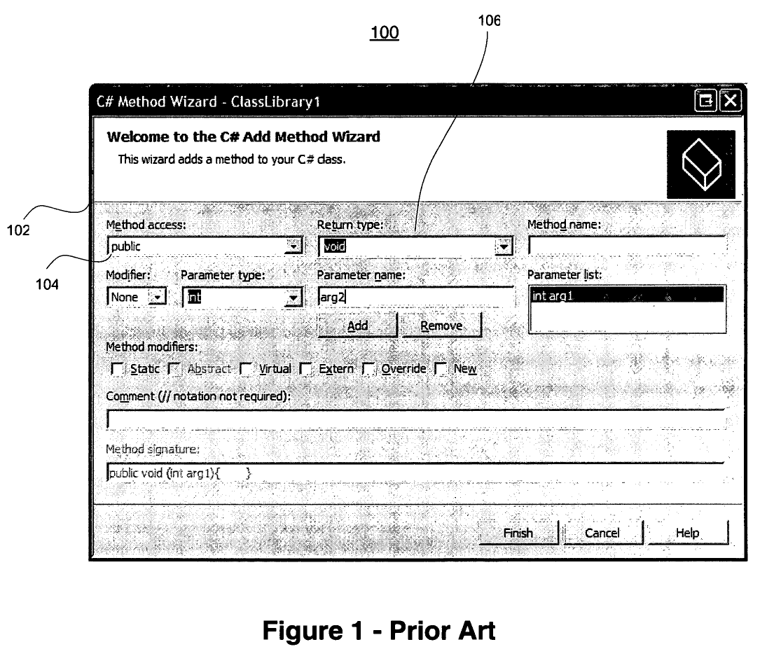

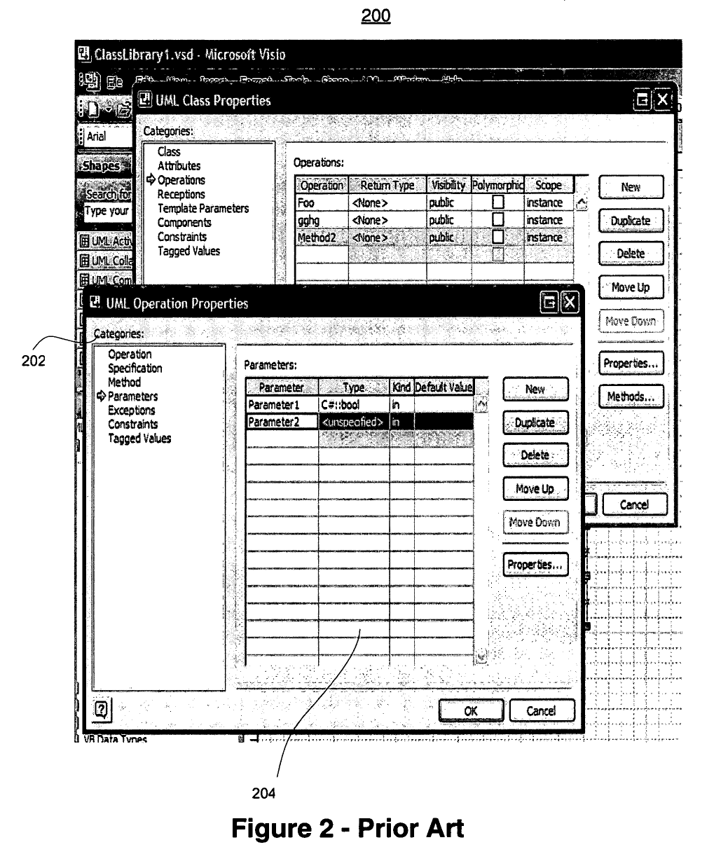

### DETAILED DESCRIPTION

Exemplary Operating Environment

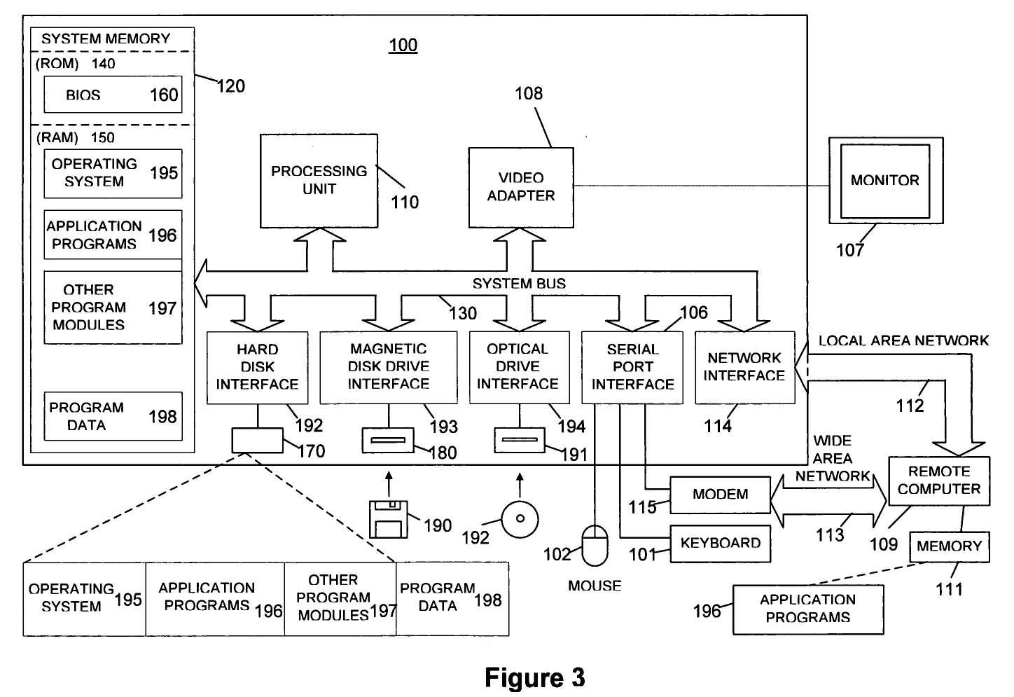

FIG. 3 is a functional block diagram of an example of a conventional general-purpose digital computing environment that can be used to implement a user interface for creating method signatures for an application component on a visual design surface in accordance with various aspects of the present invention. In FIG. 3, a computer 100 includes a processing unit 110, a system memory 120, and a system bus 130 that couples various system components, including the system memory, to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 3. The logical connections depicted in FIG. 3 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are illustrative and other techniques for establishing a communications link between the computers can be used. The existence of any of various well-known protocols such as TCP/IP, Ethernet, FTP, HTTP, Bluetooth, IEEE 802.11x and the like is presumed, and the system can be operated in a client-server configuration to permit a user to retrieve web pages from a web-based server. Any of various conventional web browsers can be used to display and manipulate data on web pages.

Description of Illustrative Embodiments

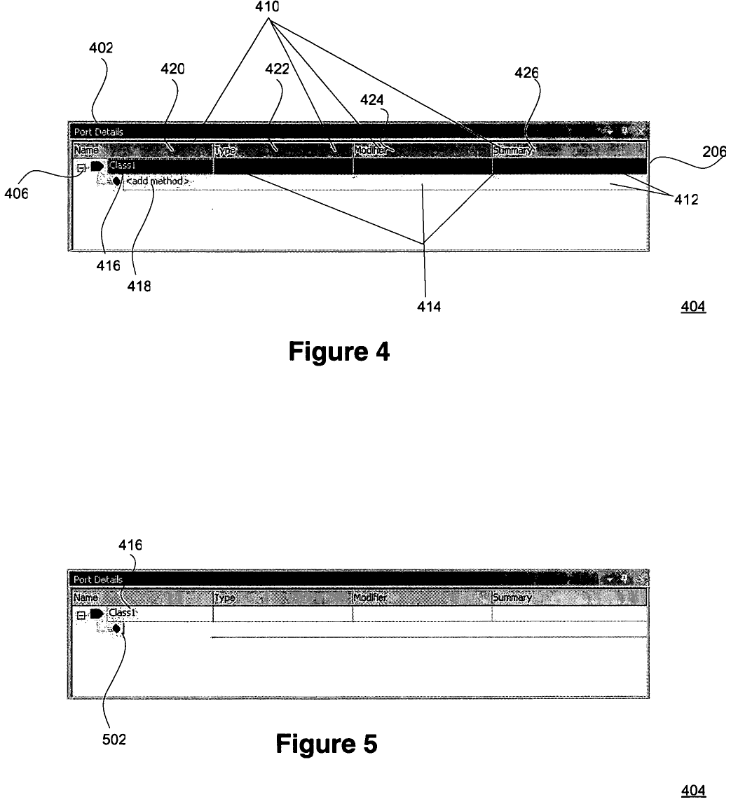

FIG. 4 illustrates a screen shot of a user interface for creating a method signature for an application component. Though the invention provides a user interface for creating a method signature, various aspects of the invention may be used in numerous other applications requiring data entry. For example, the concepts of the invention may be applied to various consumer application programs such as Microsoft® Money or a tax preparation program which require a large amount of data entry. For example, in Microsoft® Money a user inputs numerous data fields for manipulation and management of checking, credit card, and other financial entries. An aspect of the invention may be utilized to itemize such entries in place.

Moreover, an aspect of the invention may be applied to creating custom markup language such as XML. The entry of hierarchical XML data with the invention eliminates the use of text editors or word processing programs which provide no syntax guidance, or forms which are key stroke intensive.

Furthermore, another aspect of the invention may include the creation of a method signature created for a Web Service Port.

Returning to FIG. 4, a tree grid control window 402 corresponding to a selected object is shown on the visual design surface 404. The tree grid control window 402 may comprise a tree grid 406. The tree grid 406 may represent a hierarchical structure that comprises columns 410 and rows 412. The rows 412 of the tree grid 406 may be expanded or collapsed to display various levels of the hierarchical structure. The columns 410 and the rows 412 may define cells 414 for placement of data defining a method signature.

The columns 410 may comprise a name column 420, a type column 422, a modifier column 424, and a summary column 426. As those skilled in the art will realize, the tree grid 406 may comprise a number of additional columns and rows which describe method signatures. For instance, the tree grid 406 may also comprise a default value column (not shown) or array type column (not shown) providing information about an array.

Referring to FIG. 4, an object named Class1 416 is displayed on visual design surface 404. The Class1 object 416 illustrates an initial state of the tree grid 406 before entry of a method signature. A watermarked text <add method> 418 may also be displayed in the tree grid 406 in order to illustrate a field which may be selected in order to issue a particular function. For instance, the watermark text <add method> 418 may define a function for adding a method signature to an existing object.

FIG. 5 illustrates a screen shot showing the addition of a method signature in accordance with an embodiment of the present invention. The watermark text <add method> 418 of FIG. 4 has been selected by a user or developer using a selection interface device. As illustrated in FIG. 5, a cursor 502 appears in place of the watermark text <add method> 418 to allow data entry for a method signature for Class1 object 416.

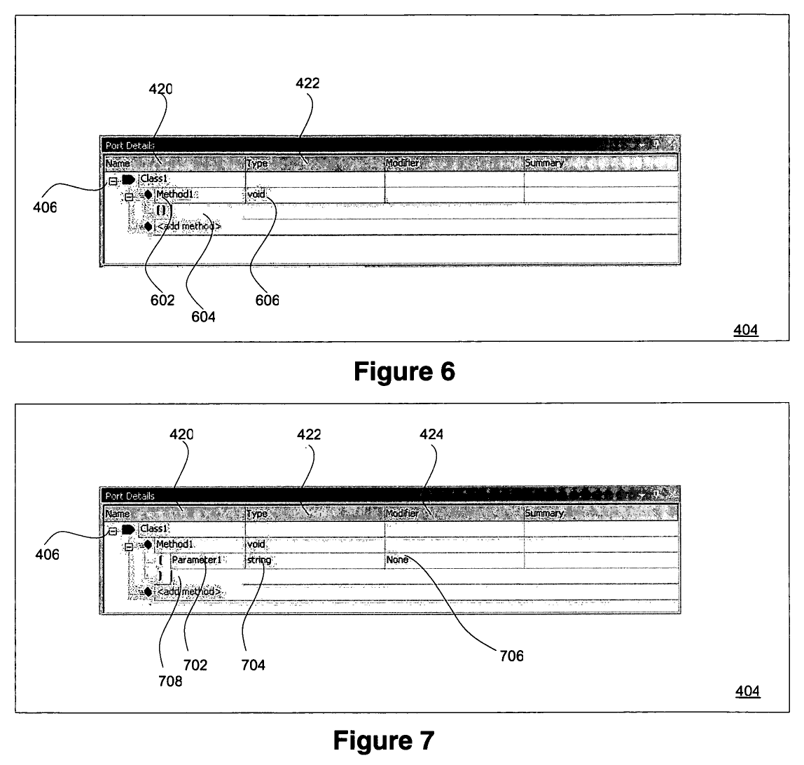

Referring to FIG. 6, a user or developer may enter a name in the name column 420 corresponding to a method which the user or developer may create. For example, a user or developer may enter a name such as Method1 602 in order to name a first method corresponding to Class1 object 416.

In addition, a user may enter a key stroke such as an open parenthesis key stroke which may cause the tree grid 406 to allow entry of parameters 604 further defining a method signature. As one skilled in the art will understand key strokes may comprise keyboard characters. The open parenthesis key stroke may provide functionality associated with the particular key stroke. For example, in FIG. 6 a developer or user may type the following data characters “Method1” (in name column 420). The user interface parses the data entry characters in real time and determines where to place each of the data entry characters. The Method1 portion of the data entry characters are placed in the name column 420. Additionally, the user interface may also utilize default values such as void 606 in type column 422. The use of default values may reduce the number of key stroke entries required to create a method signature. The user interface analyzes the open parenthesis key stroke and directly places the user interface in a mode which allows the entry of parameters 604.

FIG. 7 illustrates a screen shot of the visual design surface 404 showing the addition of a parameter for the method signature in accordance with an aspect of the invention. In FIG. 7, a developer or user may enter a name of a parameter such as Parameter1 702. After entry of Parameter1 702 in the name column 420, the user interface may utilize default values for type column 422 and the modifier column 424. For example, the user interface may utilize a default value of string 704 for the type column 422 and a default value of none 706 for the modifier column 424. After entry of the Parameter1 702 name, the user interface allows the tree grid 406 to enter a new parameter as illustrated by the location of the cursor 708 in FIG. 7.

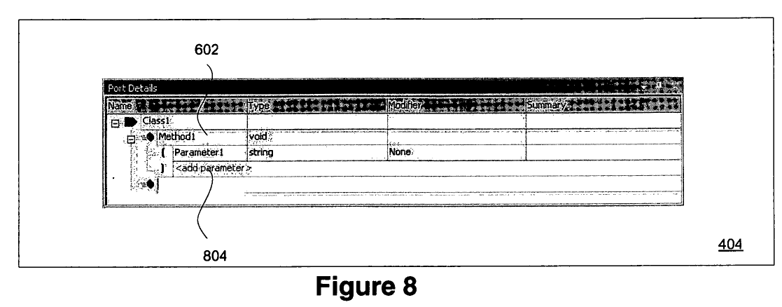

In FIG. 8, a user or developer has completed entry of the parameters for Method1 602 and the cursor 804 is positioned to allow entry of another method. A user or developer may utilize key strokes such as a semi colon or close parenthesis to advance the point of data entry to a second method signature. Alternatively, the developer or user may activate the watermark text <add method> 418 to allow data entry for a second method signature.

Table 1 shows exemplary key strokes and their associated functionality as described in a further aspect of the invention. These keys are designed to be familiar to users of the programming languages “C,” “C++,” “C#,” and Visual Basic®. Other key strokes could be used to mimic the syntax of other languages, such as XML. Those skilled in the art will realize that additional key strokes and their associated functionality may be defined for use in creating method signatures that fall with the scope of the invention.

TABLE 1

| Key Stroke | Key Stroke Functionality |
|---|---|
| , Comma | Only applies to parameters. |
| | Advance to name field for next parameter. If |
| | in the last parameter row for an Operation, |
| | this goes to the <add parameter> field so the |
| | user may type another. |
| ; Semi colon | Advance to next operation name field. |
| ) Close parenthesis | |
| ‘ Single quote | Advance to comment field. |
| / Forward slash | |
| Tab | Move to next field, left to right then top to |
| Space | bottom. |
| | If on an empty field like <add parameter> |
| | tab skips the remainder of the row and |
| | moves to the 1^{st} field on the next row. |
| ( Open parenthesis | Add a new parameter. |

As table 1 illustrates, more than one key stroke may perform similar functionality. Similar to Table 1, various key strokes may be utilized in other programming languages such as markup languages similar to XML. For example, Table 2 illustrates exemplary key strokes and their associated functionality that may be utilized for XML.

TABLE 2

| Key Stroke | Key Stroke Functionality |
|---|---|
| < Open angle bracket | Advance to name field. |
| = equal | Advance to Attribute field, if within opening |
| | tag of an element. |
| “ Single quote | Advance to attribute name field, if“ follows |
| | equal sign. |
| <! Open angle bracket and | Move to comment field. |
| exclamation point | |

As those skilled in the art will realize, numerous additional key strokes with associated functionality may be defined for various programming languages. Table 1 and Table 2 are exemplary are not intended to limit the invention to the represented key strokes and functionality.

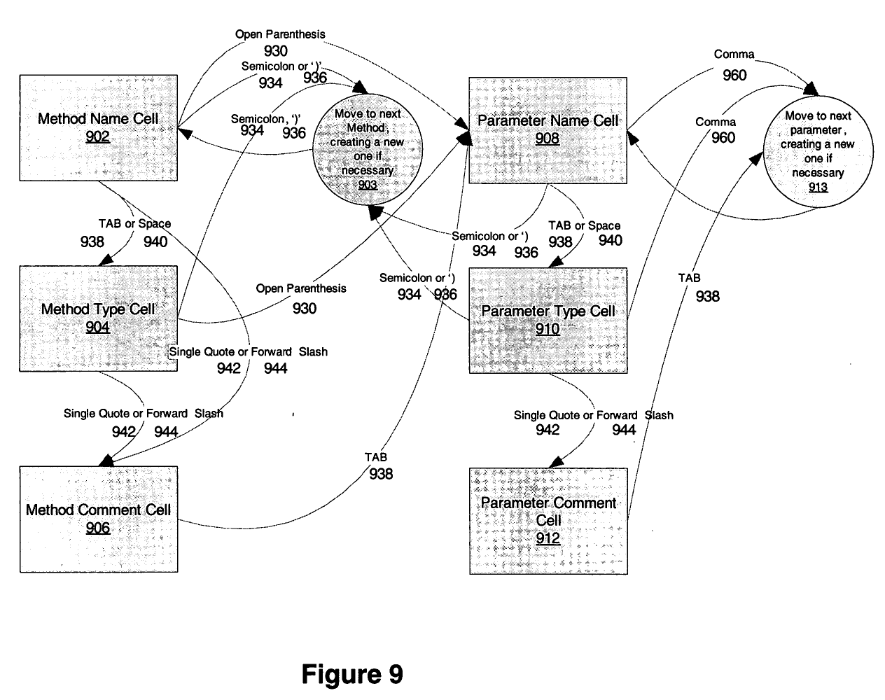

FIG. 9 illustrates a method of creating a method signature for an application component on a visual design surface utilizing various key strokes of the invention. A tree grid 406 may be utilized having columns such as a method name column, a method type column, and a message comment column. The message signature may be defined by entering data into cells of the above described columns. The entered data is parsed and the parsed data is placed into the cells of the tree grid based on the functionality, corresponding to the key strokes. For example, starting in a method name cell 902, a tab 938 or space 940 key stroke advances the point of data entry to an adjacent method type cell 904. An open parenthesis key stroke 930 advances the point of data entry to a parameter name cell 908. A semi colon 934 or close parenthesis 936 key stroke advances the point of data entry to the next method, creating a new method, if one is necessary 903. A single quote 942 or forward slash 944 advances the point of entry to the method comment field 906.

Starting in a method type cell 904, an open parenthesis 930 advances the point of data entry to a parameter name cell 908. Similar to the method name cell, a semi colon 934 or close parenthesis 936 key stroke entered into a method type cell 904 advances the point of entry to the next method, creating a new method if necessary 903. A single quote 942 or forward slash 944 key stroke advances the point of entry to a method comment field 906. Starting in a method comment cell 906 a tab key stroke advances the point of entry to a parameter name cell 908.

Similar to the method data entry, key strokes may be utilized to enter data corresponding to parameters for methods. The data defining parameters may include a parameter name field 908, a parameter type cell 910, and a parameter comment cell 912.

For example, starting in a parameter name cell 908, a tab 938 or space 940 key stroke advances the point of data entry to an adjacent parameter type cell 910. A comma key stroke 960 advances the point of data entry to a next parameter, creating a new parameter, if one is necessary 913. A semi colon 934 or close parenthesis 936 key stroke advances the point of data entry to the next method, creating a new method, if one is necessary 903.

Starting in a parameter type cell 910, a comma 960 key stroke advances the point of data entry to a next parameter, creating a new parameter, if one is necessary 913. Similar to the method name cell, a semi colon 934 or close parenthesis 936 key stroke entered into a parameter type cell 910 advances the point of entry to the next method, creating a new method if necessary 903. A single quote 942 or forward slash 944 key stroke advances the point of entry to a parameter comment field 912.

Starting in a parameter comment cell 912, a tab key stroke advances the point of entry to a next parameter, creating a new parameter, if one is necessary 913. Additionally, an enter command key stroke in any cell may optionally be used to accept inputted data or to advance data entry to the next row.

The present invention has been described in terms of preferred and exemplary embodiments thereof. Numerous other embodiments, modifications and variations within the scope and spirit of the appended claims will occur to persons of ordinary skill in the art from a review of this disclosure.

1. In a computer system having a graphical system user interface including a display and a user selection interface device, a method of creating a method signature for an application component on a visual design surface, the method comprising the steps of:
a) receiving a request to create a method signature of the application component on the visual design surface;
b) in response to a) displaying a tree grid control window on the visual design surface;
c) receiving data into a tree grid, the received data defining the method signature; and
d) displaying the received data in the tree grid control window.

2. The method of creating the method signature for the application component of claim 1, wherein the tree grid comprises columns and rows, the columns and rows defining a hierarchy of cells for the placement of the received data.

3. The method of creating the method signature for the application component of claim 2, wherein the received data comprises key strokes, the key strokes having functionality.

4. The method of creating the method signature for the application component of claim 3, wherein the received data is parsed, the parsed data placed into the hierarchy of cells of the tree grid, the placement determined by the functionality corresponding to the key strokes.

5. The method of creating the method signature for the application component of claim 4, wherein the key strokes comprise keyboard characters.

6. The method of creating the method signature for the application component of claim 5, wherein the keyboard characters comprise a first keyboard character, the first keyboard character advancing a point of data entry of the received data to a name field cell of a parameter name cell of the method signature.

7. The method of creating the method signature for the application component of claim 6, wherein the first keyboard character comprises a comma keyboard character.

8. The method of creating the method signature for the application component of claim 5, wherein the keyboard characters comprise a first keyboard character and a second keyboard character, the first and second keyboard characters for advancing a point of data entry of the received data to a second method signature.

9. The method of creating the method signature for the application component of claim 8, wherein the first keyboard character comprises a close parenthesis keyboard character and the second keyboard character comprises a semi colon keyboard character.

10. The method of creating the method signature for the application component of claim 5, wherein the keyboard characters comprise a first keyboard character or a second keyboard character, the first and second keyboard characters for advancing a point of data entry of the received data to a method comment cell.

11. The method of creating the method signature for the application component of claim 10, wherein first keyboard character comprises a single quote keyboard character and the second keyboard character comprises a forward slash keyboard character.

12. The method of creating the method signature for the application component of claim 5, wherein the keyboard characters comprise a first keyboard character or a second keyboard character, the first and second keyboard character for advancing a point of data entry of the received data to a method type cell.

13. The method of creating the method signature for the application component of claim 12, wherein the first keyboard character comprises a space keyboard character and the second keyboard character comprises a tab key keyboard character.

14. The method of creating the method signature for the application component of claim 5, wherein the keyboard characters comprise a first keyboard character for advancing a point of data entry of the received data to a parameter name cell.

15. The method of creating the method signature for the application component of claim 14, wherein the first keyboard character comprises an open parenthesis keyboard character.

16. The method of creating the method signature for the application component of claim 1, wherein the method signature is created for a Web Service Port.

17. A method of creating a method signature for an application component on a visual design surface, the method comprising the steps of:
a) receiving data from a user, the received data defining the method signature;
b) parsing the received data;
c) placing the received data in cells of a tree grid, the tree grid having a hierarchical structure, the placement of the received data in the cells of the tree grid determined by key strokes located in the parsed data; and
d) displaying the received data in the tree grid control window on the visual design surface.

18. The method of creating the method signature for the application component of claim 17, wherein the tree grid comprises columns and rows, the columns and rows defining a hierarchy of the cells of the tree grid.

19. The method of creating the method signature for the application component of claim 18, wherein the key strokes comprise keyboard characters.

20. The method of creating the method signature for the application component of claim 19, wherein the keyboard characters comprise a first keyboard character, the first keyboard character advancing a point of data entry of the received data to a name field cell of a parameter name cell of the method signature.

21. The method of creating the method signature for the application component of claim 20, wherein the first keyboard character comprises a comma keyboard character.

22. The method of creating the method signature for the application component of claim 19, wherein the keyboard characters comprise a first keyboard character and a second keyboard character, the first and second keyboard characters for advancing a point of data entry of the received data to a second method signature.

23. The method of creating the method signature for the application component of claim 22, wherein the first keyboard character comprises a close parenthesis keyboard character and the second keyboard character comprises a semi colon keyboard character.

24. The method of creating the method signature for the application component of claim 19, wherein the keyboard characters comprise a first keyboard character or a second keyboard character, the first and second keyboard characters for advancing a point of data entry of the received data to a method comment cell.

25. The method of creating the method signature for the application component of claim 24, wherein first keyboard character comprises a single quote keyboard character and the second keyboard character comprises a forward slash keyboard character.

26. The method of creating the method signature for the application component of claim 19, wherein the keyboard characters comprise a first keyboard character or a second keyboard character, the first and second keyboard character for advancing a point of data entry of the received data to a method type cell.

27. The method of creating the method signature for the application component of claim 26, wherein the first keyboard character comprises a space keyboard character and the second keyboard character comprises a tab key keyboard character.

28. The method of creating the method signature for the application component of claim 19, wherein the keyboard characters comprise a first keyboard character for advancing a point of data entry of the received data to a parameter name cell.

29. The method of creating the method signature for the application component of claim 28, wherein the first keyboard character comprises an open parenthesis keyboard character.

30. A method of creating a method signature for an application component on a visual design surface, the method comprising the steps of:
a) receiving a request from a user to create a method signature of the application component;
b) in response to a) displaying a tree grid control window on the visual design surface;
c) receiving data from the user, the received data defining the method signature;
d) parsing the received data;
e) placing the received data in cells of a tree grid, the placement of the received data in the cells determined by key strokes located in the parsed data; and
f) displaying the received data in the tree grid control window on the visual design surface.

31. The method of creating the method signature for the application component of claim 30, wherein the key strokes comprise keyboard characters.

32. The method of creating the method signature for the application component of claim 31, wherein the keyboard characters comprise a first keyboard character, the first keyboard character advancing a point of data entry of the received data to a name field cell of a parameter name cell of the method signature.

33. The method of creating the method signature for the application component of claim 32, wherein the first keyboard character comprises a comma keyboard character.

34. The method of creating the method signature for the application component of claim 31, wherein the keyboard characters comprise a first keyboard character and a second keyboard character, the first and second keyboard characters for advancing a point of data entry of the received data to a second method signature.

35. The method of creating the method signature for the application component of claim 34, wherein the first keyboard character comprises a close parenthesis keyboard character and the second keyboard character comprises a semi colon keyboard character.

36. The method of creating the method signature for the application component of claim 31, wherein the keyboard characters comprise a first keyboard character or a second keyboard character, the first and second keyboard characters for advancing a point of data entry of the received data to a method comment cell.

37. The method of creating the method signature for the application component of claim 36, wherein first keyboard character comprises a single quote keyboard character and the second keyboard character comprises a forward slash keyboard character.

38. The method of creating the method signature for the application component of claim 31, wherein the keyboard characters comprise a first keyboard character or a second keyboard character, the first and second keyboard character for advancing a point of data entry of the received data to a method type cell.

39. The method of creating the method signature for the application component of claim 38, wherein the first keyboard character comprises a space keyboard character and the second keyboard character comprise a tab key keyboard character.

40. The method of creating the method signature for the application component of claim 31, wherein the keyboard characters comprise a first keyboard character for advancing a point of data entry of the received data to a parameter name cell.

41. The method of creating the method signature for the application component of claim 40, wherein the first keyboard character comprises an open parenthesis keyboard character.

42. In a computer system having a graphical system user interface including a display and a user selection interface device, a method of data entry for a extensible markup language on a visual design surface, the method comprising the steps of:
a) receiving a request to enter data on the visual design surface;
b) parsing the received data;
c) placing the received data in cells of a tree grid, the placement of the received data in the cells determined by key strokes located in the parsed data; and
d) displaying the received data in the tree grid control window on the visual design surface.

43. The method of data entry of claim 42, wherein the extensible markup language comprises XML.
